(19) United States
(12) Patent Application Publication
(10) Pub. No.: US 2009/0129671 A1
(43) Pub. Date: May 21, 2009

(54) METHOD AND APPARATUS FOR IMAGE SEGMENTATION

(75) Inventors: Qingmao Hu, Singapore (SG); Wieslaw L. Nowinski, Singapore (SG)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: AGENCY FOR SCIENCE, TECHNOLOGY AND RESEARCH, Singapore (SG)

(21) Appl. No.: 11/910,304

(22) PCT Filed: Mar. 28, 2006
(86) PCT No.: PCT/SG2006/000074

§ 371 Date: Apr. 23, 2008

Related U.S. Application Data
(60) Provisional application No. 60/666,711, filed on Mar. 31, 2005.

(51) Int. Cl. G06K 9/34; G06K 9/00

(52) U.S. Cl. 382/173; 382/131

(57) ABSTRACT

A 3D image may be segmented based on one or more intensity thresholds determined from a subset of the voxels in the 3D image. The subset may contain voxels in a 2D reference slice. A low threshold and a high threshold may be used for segmenting an image, and they may be determined using different thresholding methods, depending on the image type. In one method, two sets of bordering pixels are selected from an image. A statistical measure of intensity of each set of pixels is determined. An intensity threshold value is calculated from the statistical measures for segmenting the image. In another method, the pixels of an image are clustered into clusters of different intensity ranges. An intensity threshold for segmenting the image is calculated as a function of a mean intensity and a standard deviation for pixels in one of the clusters. A further method is a supervised range-constrained thresholding method.

### CROSS-REFERENCE TO RELATED APPLICATION

This application claims the benefits of U.S. provisional application No. 60/666,711 filed on Mar. 31, 2005, the contents of which are incorporated herein by reference.

### FIELD OF THE INVENTION

The present invention relates generally to image processing, and more particularly to methods and apparatus for image segmentation.

### BACKGROUND

Image processing has wide applications. For example, magnetic resonance (MR) images of human brains are often segmented before further analysis. Segmentation is often necessary because the tissue classes visible in typical MR images can include white matter (WM), grey matter (GM), cerebrospinal fluid (CSF), meninges, bone, muscle, fat, skin, or air. Additional classes may include edema, tumor, hemorrhage or other abnormalities. These different tissue classes have different image intensities and thus an MR image can be segmented based on the image intensities. For example, it may be desirable to segment brain tissues (WM and GM) from other non-brain matters.

A number of approaches of image segmentation have been developed. Different approaches have been taken depending on the types of the images. L. P. Clarke et al. reviewed various approaches for MR image segmentation in “MRI Segmentation: Methods and Application”, Magnetic Resonance Imaging, (1995), Vol. 13, pp 343-368, the contents of which are incorporated herein by reference.

The existing imaging analysis techniques can be divided into two categories: single-contrast and multi-contrast. In a single-contrast image, also called grey-scale or single image, the intensities of the pixels or voxels in a two-dimensional (2D) or three-dimensional (3D) image of an object vary on a single grey scale. Multi-contrast images, also called multi-spectral images, of an object have different grey-scale contrasts or colors. Traditionally, different imaging processing techniques are applied to the two types of images. A single-contrast image typically contains less information than multi-contrast images. Thus, a technique applicable to analyzing multi-contrast images is often less applicable to analyzing single contrast images. For example, clustering techniques have been commonly employed for unsupervised (automated) segmentation of multi-contrast images but have had only limited application for segmenting single-contrast images.

Several approaches have been developed for segmenting single-contrast images. One of the widely used techniques is thresholding. In such a technique, a threshold is selected and the voxels/pixels of an image are segmented depending on whether each voxel/pixel has a measured intensity meeting a selected threshold. Both a low threshold and a high threshold may be used.

There are a number of conventional approaches of selecting the threshold. These approaches generally fall within two categories: curve fitting and model fitting. In a curve fitting approach, the pixel intensity histogram is fitted to a curve function, such as a Gaussian curve. An intensity threshold is then selected from a point on the fitted-curve, such as a valley point of the curve. In a model-fitting approach, an empirical formulae or a model is used to calculate the threshold from the intensities of the voxels/pixels.

Each of the conventional approaches has some shortcomings. As can be appreciated, such shortcomings relate to difficulties arising from two factors. First, different tissue classes may have different relative intensities in MR images of different pulse sequences, such as T1-weighted, T2-weighted, proton density (PD) weighted, spoiled gradient-recalled (SPGR), and fluid attenuation inversion recovery (FLAIR). Second, the voxels/pixels for different tissue classes are often not well isolated either in space or in intensity, or in both. Different tissues may have overlapping intensities, both natural overlapping and overlapping due to the imaging process such as field inhomogeneity and noises, such as noise due to movement of the imaged object, introduced during imaging.

For example, one problem with the conventional techniques is that some techniques, such as the curve-fitting approach, do not work well when there is strong noise or field inhomogeneity. A problem with the model-fitting approach is that it is difficult to obtain a formula or a model that can work well in widely varying imaging conditions and can account for variations in individual objects to be imaged.

Further, in conventional image segmentation techniques, thresholds for 3D images are typically determined in one of two ways. One is to determine a global threshold from all voxels in the image and to use this global threshold to segment the 3D image. The other is to divide the voxels of the 3D image into subsets, such as 2D slices, and determine local thresholds for each subset/slice. Each subset or slice is then segmented using the corresponding local threshold. A problem with both approaches is that extensive computation is required. Another problem is that some 2D slices may not include sufficient voxels or classes of voxels for accurate thresholding.

Thus, there is a need for methods and apparatuses for image segmentation that can overcome one or more problems mentioned above.

### SUMMARY OF THE INVENTION

In accordance with an aspect of the present invention, there is provided a method of segmenting a plurality of pixels of an image based on intensity. The method comprising: selecting first and second clusters of pixels from the plurality of pixels, the first cluster of pixels having intensities in a first range, the second cluster of pixels having intensities in a second range, the intensities in the second range being higher than the intensities in the first range; selecting a first set of pixels from the first cluster and a second set of pixels from the second cluster, wherein each pixel of the first and second sets neighbors at least one pixel from the other one of the first and second sets in the image; determining a statistical measure of intensity of the first set of pixels and a statistical measure of intensity of the second set of pixels; and computing an intensity threshold value from the statistical measures for segmenting the plurality of pixels. The plurality of pixels may be clustered into a plurality of clusters each having a ranking in intensity, where the first and second clusters have adjacent rankings in intensity. Each statistical measure may be selected from a mean, a median, and a mode. The pixels may be clustered by fuzzy C-means clustering.

In accordance with another aspect of the present invention, there is provided a method of segmenting a plurality of pixels of an image based on intensity. The method comprising: clustering the plurality of pixels into a plurality of clusters each having pixels of intensities in a respective range; determining a mean intensity value Ī and a standard deviation σ from Ī for pixels in one of the clusters; and determining an intensity threshold value Iₜ for segmenting the plurality of pixels, wherein Iₜ=Ī+βσ, β being a number from 0 to about 3. The clustering may comprise fuzzy C-means clustering.

In accordance with another aspect of the present invention, there is provided a method of segmenting a three-dimensional (3D) image based on intensity. The 3D image comprises a set of voxels each having an intensity and being associated with one of a plurality of voxel classes. The method comprising: selecting a subset of the set of voxels, the subset having voxels respectively associated with each one of the voxel classes; determining an intensity threshold from the subset of voxels; and segmenting the 3D image according to the intensity threshold. The subset of voxels may be selected from a two-dimensional (2D) slice in the 3D image. Both a low intensity threshold and high intensity threshold may be determined, according to different methods of thresholding depending on the type of the image. A region of interest in the image may be determined by: classifying the subset of voxels into background voxels having intensities in a first range and foreground voxels having intensities in a second range, the intensities in the second range being higher than the intensities in the first range; and finding the largest group of connected foreground voxels, the largest group of connected foreground voxels and the subset of voxels surrounded by the largest group of connected foreground voxels forming the region of interest.

In accordance with another aspect of the present invention, there is provided a computer readable medium storing thereon computer executable code, the code when executed by a processor of a computer causes the computer to carry out any of the methods described above.

In accordance with another aspect of the present invention, there is provided a computing device comprising a processor and persistent storage memory in communication with the processor storing processor executable instructions adapting the device to carry out any of the methods described above.

In accordance with another aspect of the present invention, there is provided an apparatus for segmenting a plurality of pixels of an image, comprising: means for selecting first and second clusters of pixels from the plurality of pixels, the first cluster of pixels having intensities in a first range, the second cluster of pixels having intensities in a second range, the intensities in the second range being higher than the intensities in the first range; means for selecting a first set of pixels from the first cluster and a second set of pixels from the second cluster, wherein each pixel of the first and second sets neighbors at least one pixel from the other one of the first and second sets in the image; means for determining a statistical measure of intensity of the first set of pixels and a statistical measure of intensity of the second set of pixels; and means for computing an intensity threshold value from the statistical measures for segmenting the plurality of pixels.

In accordance with another aspect of the present invention, there is provided an apparatus for segmenting a plurality of pixels of an image, comprising: means for clustering the plurality of pixels into a plurality of clusters each having pixels of intensities in a respective range; means for determining a mean intensity value Ī and a standard deviation σ from Ī for one of the clusters; and means for determining an intensity threshold value Iₜ for segmenting the plurality of pixels, wherein Iₜ=Ī+ασ, α being a number from 0 to about 3.

In accordance with another aspect of the present invention, there is provided an apparatus for segmenting a three-dimensional (3D) image, the 3D image comprising a set of voxels each having an intensity and being associated with one of a plurality of voxel classes, the apparatus comprising: means for selecting a subset of the set of voxels, the subset having voxels respectively associated with each one of the voxel classes; means for determining an intensity threshold from the subset of voxels; and means for segmenting the 3D image according to the intensity threshold.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic block diagram of a computer;

FIG. 2 is a flowchart of a method of image segmentation;

FIG. 3A is a MR image of a head;

FIG. 3B is a region defined by the skull in the image of FIG. 3A;

FIGS. 4 to 6 are flowcharts for the method shown in FIG. 2;

FIG. 7 is a flowchart for a method of thresholding;

FIG. 8 is a flowchart for a another method of thresholding;

FIG. 9 is a flowchart for the method of image segmentation of FIG. 2;

FIG. 10A is an image of a reference slice of a PD-weighted MR image of a human head;

FIG. 10B is a binarized image showing the ROI selected from the reference slice of FIG. 10A;

FIG. 10C is an intensity histogram of pixels in the ROI of FIG. 10B;

FIG. 10D is an intensity histogram of pixels at the boundary of grey matter (GM) and cerebrospinal fluid (CSF) in the ROI of FIG. 10B;

FIG. 10E is a binarized image of the boundary pixels in FIG. 10D;

FIGS. 10F and 10G are binarized images of the reference slice of FIG. 10A based on different thresholds;

FIG. 10H is a segmented image of the ROI of FIG. 10B;

FIGS. 11A to 11C are respectively a T₁-weighted MR image of a head and its binarized and segmented images;

FIGS. 12A to 12C are respectively a T₂-weighted MR image of a head and its binarized and segmented images; and

FIGS. 13A to 13C are respectively a FLAIR MR image of a head and its binarized and segmented images.

### DETAILED DESCRIPTION

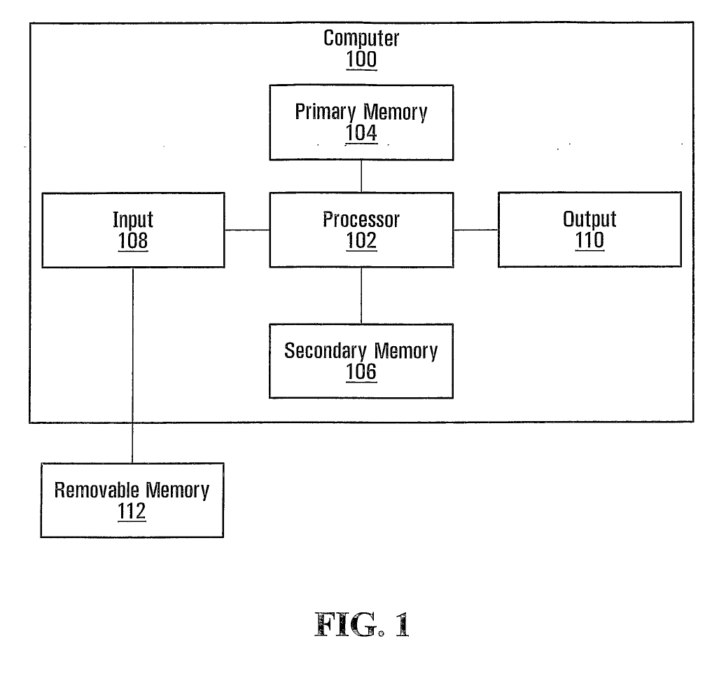

Exemplary embodiments of the present invention include methods of image segmentation and thresholding. These methods may be performed, at least in part, by a computer device such as computer 100 shown in FIG. 1, exemplary of embodiments of the present invention.

Computer 100 has a processor 102, which communicates with primary memory 104, secondary memory 106, input 108 and output 110. Computer 100 may optionally communicate with a network (not shown).

Processor 102 includes one or more processors for processing computer executable codes and data.

Each of memories 104 and 106 is an electronic storage comprising a computer readable medium for storing electronic data including computer executable codes. Primary memory 104 is readily accessible by processor 102 at runtime and typically includes a random access memory (RAM). Primary memory 104 only needs to store data at runtime. Secondary memory 106 may include persistent storage memory for storing data permanently, typically in the form of electronic files. Secondary memory 106 may also be used for other purposes known to persons skilled in the art. A computer readable medium may be any available media accessible by a computer, either removable or non-removable, either volatile or non-volatile, including any magnetic storage, optical storage, or solid state storage devices, or any other medium which may embody the desired data including computer executable instructions and can be accessed, either locally or remotely, by a computer or computing device. Any combination of the above is also included in the scope of computer readable medium.

Input 108 may include one or more suitable input devices, and typically includes a keyboard and a mouse. It may also include a microphone, a scanner, a camera, and the like. It may also include a computer readable medium such as removable memory 112 and the corresponding device for accessing the medium. Input 108 may be used to receive input from the user. An input device may be locally or remotely connected to processor 102, either physically or in terms of communication connection.

Output 110 may include one or more output devices, which may include a display device, such as a monitor. Suitable output devices may also include other devices such as a printer, a speaker, and the like, as well as a computer writable medium and the device for writing to the medium. Like an input device, an output device may be local or remote.

Computer 100 may communicate with other computer systems (not shown) on a network (not shown).

It will be understood by those of ordinary skill in the art that computer system 100 may also include other, either necessary or optional, components not shown in the figure.

Memory 104, 106 or 112 may store computer executable code, which when executed by processor 102 causes computer 100 to carry out any of the methods described herein.

For example, the computer executable code may include code for selecting pixels based on one or more of the criteria discussed herein, code for determining a statistical measure of intensity for each one of the selected sets, and codes for computing an intensity threshold value for segmenting pixels as a weighted average of the statistical measures. The program code may also include code for clustering pixels into a plurality of clusters, code for determining a mean intensity value and a standard deviation for a set of pixels, code for determining intensity threshold values based on one of the formulae described herein, and code for selecting a subset from a set of voxels.

As can be appreciated, methods described herein may also be carried out using a hardware device having circuits for performing one or more of the described calculations or functions. For example, the functions of one or more of the above mentioned program code may be performed by a computing circuit.

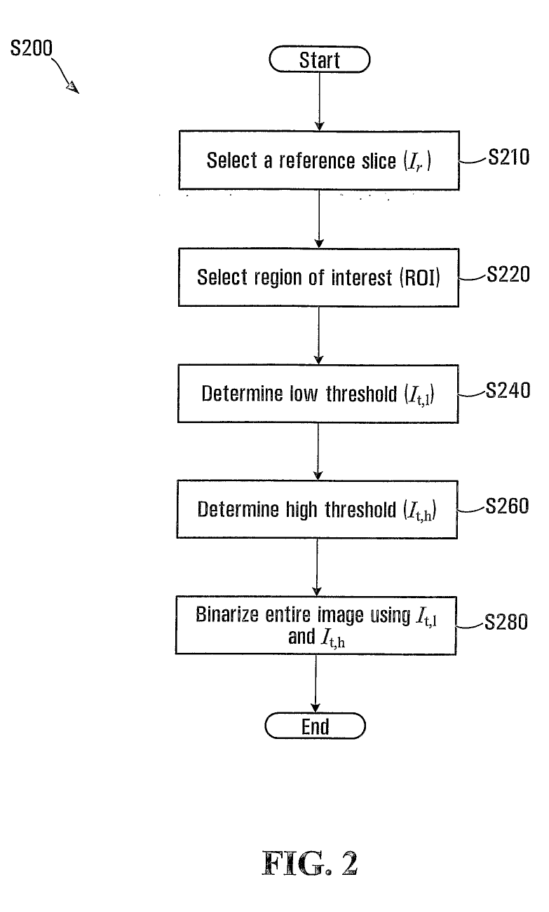

A three-dimensional (3D) image can be segmented according to the segmentation process S200 illustrated in FIGS. 2 and 4 to 9, exemplary of embodiments of the present invention. Process S200, as well as other exemplary embodiments of the present invention described below, will be illustrated with reference to a particular type of images, magnetic resonance (MR) images of a head of a human subject. However, it is understood that embodiments of the present invention can be applied for segmenting other types of images.

The MR image may be taken using any suitable techniques and may include T₁-weighted, T₂-weighted, proton density (PD)-weighted, spoiled gradient-recalled (SPGR), fluid attenuation inversion recovery (FLAIR) images, and the like.

Head tissues visible in typical MR images include cerebrospinal fluid (CSF), brain tissues such as white matter (WM) and grey matter (GM), air, bone/skull, muscle, fat, skin, eye, meninges, bone marrows, adipose, and the like. Depending on the imaging technique, different tissue classes may have different image intensities. Table I lists the relative intensities for some of the main tissue classes within the skull, and the suitable corresponding thresholding methods which will be described below. High-intensity non-brain tissues are not shown in Table I. Possible high-intensity non-brain tissues include bone marrow and adipose, which can be brighter than brain tissues in some MR images, such as T₁-weighted, SPGR, and FLAIR images. In T₂-weighted images, the globes (or more commonly known as eyeballs) can be brighter than CSF.

TABLE I
Relative Intensity Rankings of Tissue Classes (1 = lowest,
4 = highest) and Suitable Thresholding Method

| | | | | | Thresholding | |
|---|---|---|---|---|---|---|
| Imaging | | | | | Method | |
| Technique | Bone/Air | WM | GM | CSF | l_{t,l} | l_{t,h} |
| PD-weighted | 1 | 2 | 3 | 4 | MASD | TPBP |
| T₂-weighted | 1 | 2 | 3 | 4 | MASD | TPBP |
| T₁-Weighted | 1 | 4 | 3 | 2 | SRCT | MASD |
| SPGR | 1 | 4 | 3 | 2 | SRCT | MASD |
| FLAIR | 1 | 3 | 4 | 2 | SRCT | MASD |

For the purpose of illustration, it is assumed that GM and WM (referred to as brain tissues) are the tissues of interest and are to be segmented from the other tissue classes.

While the voxels, or pixels in two-dimensional (2D) images, can be initially classified into different clusters based entirely on intensity distribution, such as by fuzzy C-means (FCM) clustering, the initial classification is often unsatisfactory for segmentation purposes, as can be understood by persons skilled in the art. Thus, further refinement, improvement, or processing are often necessary or desirable for determining good threshold, as illustrated below.

At S210, a reference slice is selected from a 3D image. As can be appreciated, this is not necessary if the image to be segmented is two-dimensional.

As is conventional, a 3D image is represented by a set of voxels with various intensities and coordinates. The coordinate system may be conventional. For the purpose of illustration, it is assumed herein that each voxel (v) of a 3D image has three Cartesian coordinates x, y and z, where x runs from the subject's right hand side to the left hand side, y from anterior to posterior, and z from superior to inferior. However, another suitable coordinate system may be used, as can be readily understood by persons skilled in the art. For convenience, the intensity of a voxel v is denoted I and the image can be represented by an intensity function I(x,y,z). In practice, images obtained by time-sequenced scanning techniques are typically represented by time-sequenced intensity histograms (I(t)), where the time “t” can be readily converted to coordinates. Thus, I(t) and I(x,y,z) are treated herein as interchangeable.

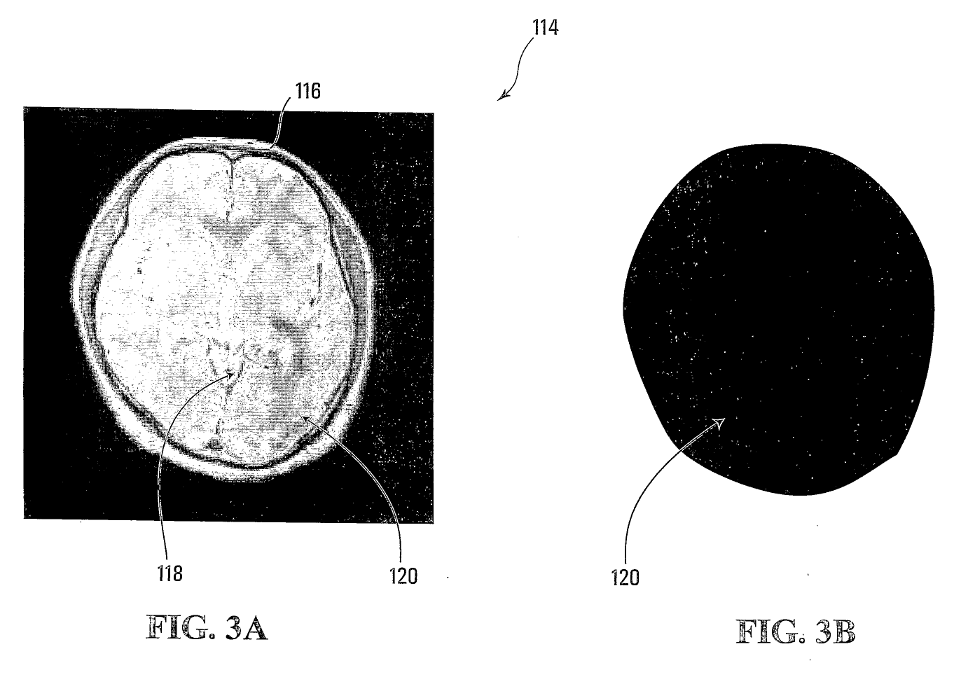

Typically, a reference slice may be selected such that all tissue classes of interest are represented within the slice. This way, the threshold(s) derived from the reference slice can be used to segment the entire 3D image. As can be understood, it can be advantageous not having to determine thresholds for each slice of the 3D image, which can be time-consuming or difficult and may not even be possible. Therefore, the reference slice may be selected such that it has pixels representing all of WM, GM, CSF, air, and skull tissues. A possible reference slice is the axial slice passing through the anterior and posterior commissures, which may be determined through specifying midsagittal plane and the two commissures. Additional information on selecting the reference slice can be found in Hu Q. et al, “Fast, accurate and automatic extraction of the modified Talairach cortical landmarks from magnetic resonance images”, Magnetic Resonance in Medicine, (2005), vol. 53, pp. 970-976 (“Hu(I)”), the contents of which are incorporated herein by reference. In practice, this reference slice may be approximated by an axial slice with the third ventricle present and without eyes, as shown in FIG. 3A.

The reference slice may be selected either manually or automatically. For example, the reference may be automatically selected, such as with a computer, by:
(1) determining the average intensity (Nᵢ) for each axial slice (Sᵢ) of the 3D image, as described in Hu(I);
(2) determining the axial slice (Sₘ) which has the maximum average intensity (Nₘ); and
(3) starting from Sₘ and along the superior direction, finding the first axial slice (Sᵣ) whose average intensity Nᵣ is less than 0.9Nₘ as the reference slice.

FIG. 3A shows an example reference slice 114 of a 3D image (not shown). The image is a PD-weighted MR image of a human head. As can be appreciated, the skull 116 and the brain tissues 118 of the head are visible. The brain region 120 enclosed in skull 116 is typically the region of interest (ROI). The ROI may also include the skull region or a portion thereof.

Assuming the reference slice is an axial slice, it consists of all voxels with a constant z, such as z₀. The voxels in the reference slice thus have coordinates (x,y,z₀). The intensity for the reference slice can thus be denoted by Iᵣ (x,y,z₀). For brevity, the z-coordinate for a reference slice is omitted and the intensity function for the reference slice is denoted by Iᵣ(x,y) or simply Iᵣ hereinafter. Further, the intensity points for the reference slice are also referred to as pixels, as is conventional for 2D images.

At S220, the ROI is selected. For illustration purposes, the ROI of the reference image is assumed to be the 2D cross-sectional space defined by the skull. FIG. 3B shows a ROI 120 binarized from the image of FIG. 3A.

As is conventional, to binarize an image, each pixel of the image can be associated with a binary indicator having one of two possible values, such as 1 and 0. A binarized image will only have two possible intensities, such as black or white. In comparison, when an image is segmented, a pixel can retain its original intensity if it is an object pixel.

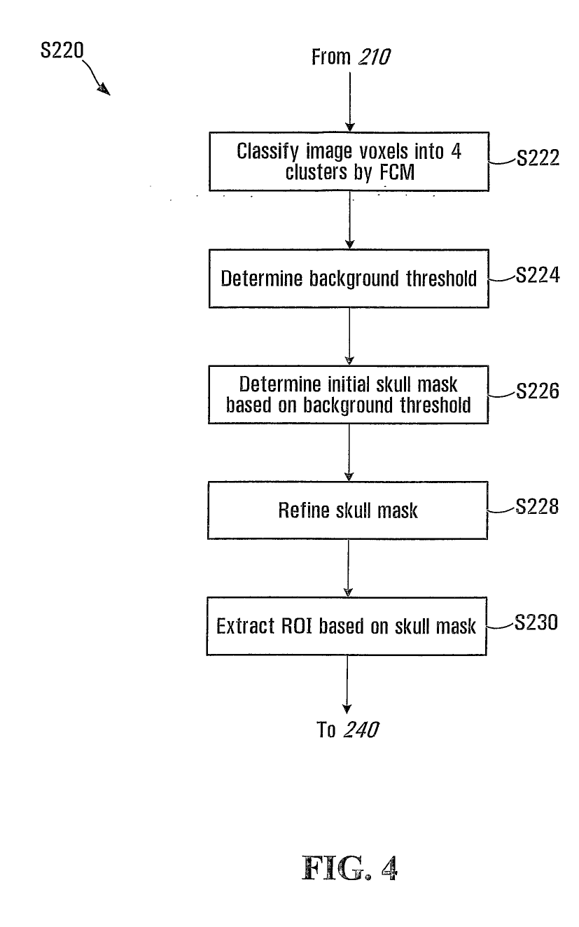

As illustrated in FIG. 4, the ROI may be selected as follows. At S222, the voxels of the 3D image, are classified into four clusters (C1 to C4) corresponding to air and bone, GM, WM, and CSF. As can be appreciated, the specific correspondence between a cluster and a tissue class will depend on the type of images taken (see Table I). The classification of the voxels may be indicated by associating each voxel with a class indicator having one of four possible values, such as 1 to 4.

The voxels may be classified or clustered with an FCM clustering technique. The FCM technique is known to persons skilled in the art and will not be described in detail herein. Description of the FCM technique and some other techniques can be found in Recognition with Fuzzy Objective Function Algorithms, by J. C. Bezdek, Plenum Press, New York, 1981, the content of which are incorporated herein by reference. Some other conventional classification techniques may also be suitable, which include curve fitting and empirical formulae. However, FCM clustering may be advantageous, for example, over a curve fitting technique, because FCM does not assume noise model and can give good results even if the noise level and intensity inhomogeneity are high.

For example, the voxels may be iteratively partitioned into overlapping classes, or clusters, according to their intensity values with an FCM algorithm. The intensities of the voxels in each particular cluster are within a particular range. The intensity ranges of different clusters are different, and two clusters will have no overlapping intensity ranges.

Different clusters and their intensity ranges may be ranked according to a statistical measure of the intensities of their corresponding pixels, such as the minimum intensity, the maximum intensity, the median intensity, the arithmetic mean (average) intensity, the mode intensity, or the like. It is assumed below for ease of description that the clusters are ordered according to their intensity rankings, in ascending order. Thus, the first cluster (C1) has the lowest intensity ranking and the last cluster has the highest intensity ranking. This order is assumed for all subsequent classification or clustering below. Two clusters, or two intensity ranges, are considered bordering or adjacent when they are ranked one next to the other. Thus, for example, the intensity ranges of cluster 3 and cluster 4 are adjacent ranges and clusters 3 and 4 have adjacent rankings in intensity.

At S224, a background threshold (I_{B}) is calculated by:

I_{B}=Iₘₐₓ^{C1}+c. (1)

Here, Iₘₐₓ^{C1} is the maximum intensity of the first cluster C1, and “c” is a constant such as about 5. In MR images, the first cluster typically corresponds to air and bone. The constant c may have a value other than 5, such as from 0 to 5 or higher. The value of c may be chosen through testing or based on experience. It has been found that for typical MR images a value of about 5 can produce good results when the image data contains relatively high levels of noise and/or imhomogenity.

At S226, each pixel in the reference slice is designated as either background or foreground. This can be accomplished by binarizing the reference slice and associating each pixel with a binary indicator, such as 1 and 0. For this purpose, a skull mask m(x, y) may be constructed where,

if Iᵣ(x,y)<I_{B},m(x,y)=0; otherwise, m(x,y)=1. (2)

A pixel in the reference slice is designated as a background pixel if its corresponding skull mask value is 0, or a foreground pixel if its corresponding skull mask value is 1.

The initial skull mask may not be ideal for defining the ROI. For example, there may be more than one isolated foreground components. Within a connected foreground component, there may be pockets of background pixels surrounded by foreground pixels, referred to as holes herein. Thus, the skull mask may need to be refined.

At S228, the skull mask m(x, y) is refined. Such refinement can be readily carried out with conventional techniques by persons skilled in the art. For example, refinement may be carried out by first performing morphological closing in the skull mask, such as with a square structuring element of side 3 mm, to connect small gaps in the skull mask due to very low intensity of bones, as described in Hu(I), supra. The morphological closing may be carried out with a suitable conventional morphological technique.

To eliminate small, isolated foreground spots, such as those in the skull region, the largest group of connected foreground pixels in m(x, y) are determined and the other foreground pixels are re-designated as background pixels, for example, by setting their associated binary indicator to 0.

To eliminate holes in the remaining foreground component, each background pixel surrounded by foreground pixels is re-designated as foreground pixels, for example, by setting its associated binary indicator to 1.

At S230, the ROI is selected as the region defined by the foreground pixels in the final skull mask m(x,y). FIG. 3B shows an exemplary ROI so selected, where the foreground pixels are displayed as black and background pixels displayed as white.

After the ROI is selected, an intensity threshold for segmenting the image can be determined. Both a low and a high threshold value may be determined. In some applications, only one threshold needs to be determined. In this example, both low and high thresholds are determined to identify GM and WM.

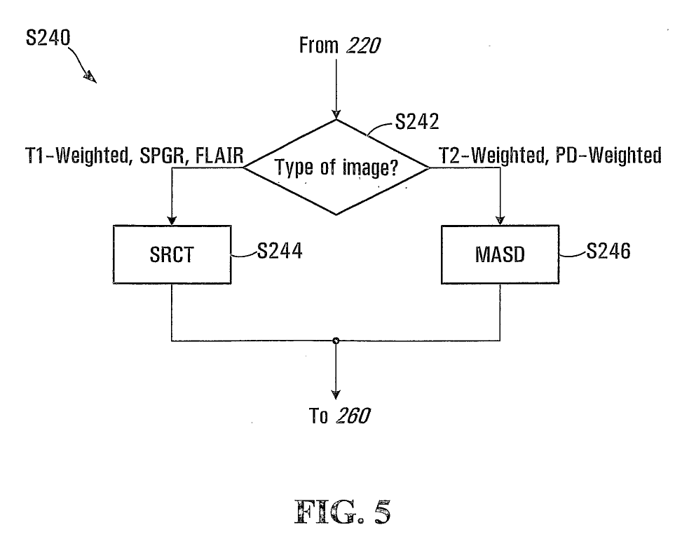

The low threshold (I_{t,l}) is determined at S240, as illustrated in FIGS. 2 and 5.

As illustrated in FIG. 5, a suitable thresholding method is selected at S242 based on the particular type of image to be segmented. For T1-weighted, SPGR and FLAIR images, a supervised range-constrained thresholding (SRCT) method is used at S244, while for T2-weighted and PD-weighted images, a mean and standard deviation (MASD) method is used at S246. Details of the SRCT method have been described in Hu Q. et al., “Supervised Range-Constrained Thresholding”, IEEE Transactions on Image Processing, 2006, vol. 15, pp. 228-240 (“Hu(II)”), the contents of which are incorporated herein by reference. The MASD method will be described below.

The choice of thresholding method may be made based on anatomical knowledge and/or any other prior acquired information about the different classes of pixels present in the image. As will become clear below, such knowledge and information can also influence how a thresholding method is applied. For example, knowledge about the proportions of different tissue classes such as air, bone and CSF within the ROI may be used to determine the low threshold for a T1-weighted, SPGR or FLAIR image. The SRCT method is an example method that takes advantage of such knowledge. As can be appreciated, for T1-weighted, SPGR, and FLAIR images, the low threshold is to be used to separate WM/GM from both CSF and bone/air. There exists substantial intensity overlap between CSF and brain tissues in these types of images. Thus, the low threshold is difficult to choose with conventional thresholding methods. The SRCT method, on the other hand, may be advantageously used for determining the low threshold for segmenting these images with good results.

In the SRCT method, a threshold is determined by minimizing the classification error within a frequency range of the background. In a given image, the frequency (number) of pixels at each different intensity level can vary and the proportion of background pixels to the pixels in the ROI can vary at different frequencies. The frequency range of the background in which the proportion of the background to the ROI varies may be estimated through supervision as described in Hu(II), supra. Briefly, a lower limit and a higher limit of the frequency range of the background are determined by supervision, which may be in the form of training when a number of sample mages with ground truth are available, or in the form of approximation based on any prior knowledge or visual judgement when sample images are not available.

For T2-weighted and PD-weighted images, the lower threshold is to be used for separating air/bone and WM. There is relatively less intensity overlap between air/bone and WM. Thus, the MASD method may be effective and sufficient.

As illustrated in FIG. 2, the high threshold (I_{t,h}) is determined next (at S260). As can be appreciated, the order of determining low and high thresholds may be reversed.

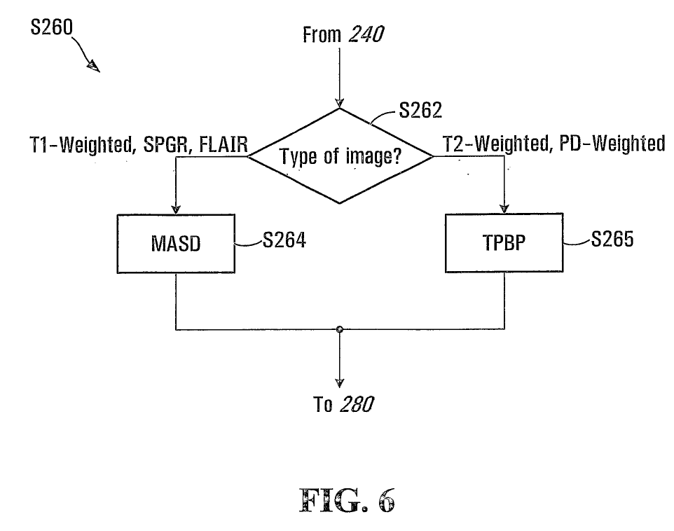

As illustrated in FIG. 6, different thresholding methods are again used for different types of images. For T1-weighted, SPGR, and FLAIR images, the MASD method may be used, at S264, because for these images the high threshold is to be used to separate WM or GM from high intensity non-brain tissues such as bone marrow and adipose.

For T2-weighted and PD-weighted images, the high threshold is to be used to separate GM and CSF. Again, this separation can be difficult with a conventional thresholding method. Thus, a method referred to herein as thresholding with pairs of bordering pixels (TPBP) is used, at S265. As will become clear, the TPBP method is suitable for separating two classes of pixels that are adjacent to each other both spatially and in intensity ranking. As can be appreciated, CSF and GM/WM pixels are such classes of pixels in T2-weighted and PD-weighted images.

The suitable thresholding methods for each type of MR images are also listed in Table I for easy reference.

Before describing how each thresholding method is implemented in process S200, a general description of the TPBP and MASD methods is first given below, with reference to a 2D image, which can be a 2D reference slice from a 3D image. While pixels are used below to represent the data points in the intensity histogram, it is understood that the data points can also be voxels, such as voxels in a 2D slice from a 3D image.

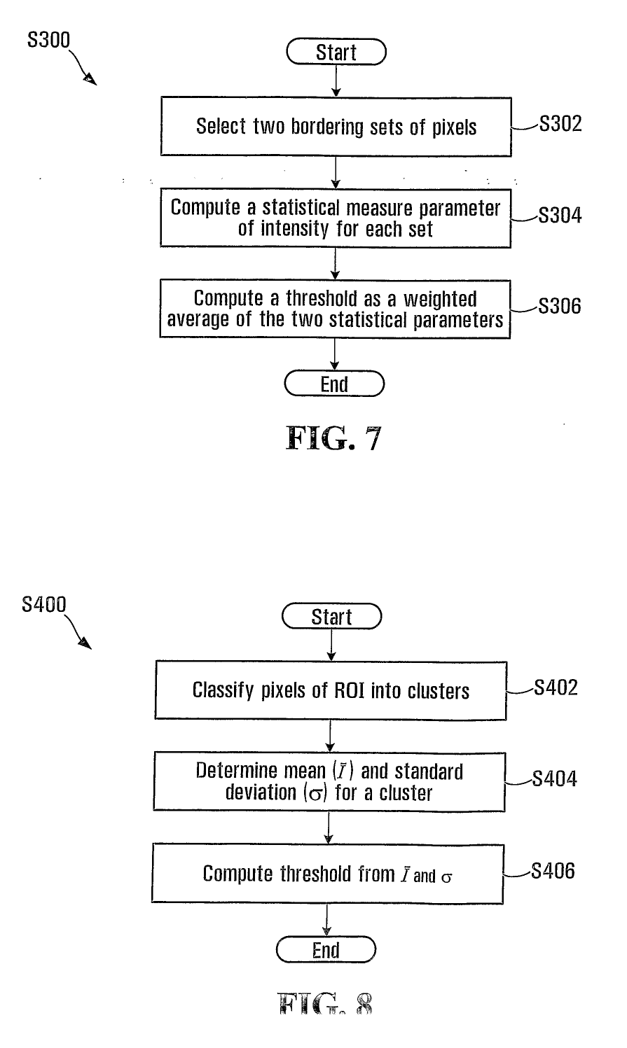

FIG. 7 illustrates a process S300 of thresholding according to the TPBP method, exemplary of an embodiment of the present invention.

The TPBP method is suitable for processing images that have the following characteristics. The image has pixels that can be divided into at least two identifiable classes. Each class of pixels may form at least one connected region in space. The two classes are bordering classes in the sense that the pixel intensity ranges of the two classes are close to each or even overlap and that at least some pixels in each class are adjacent (neighboring) pixels of the other class in space. For example, in a magnetic resonance image of a human head, the two classes may respectively correspond to pixels representing CSF and brain tissues including both WM and GM. Thus, the image pixels may be classified using a suitable classification technique, including conventional classification techniques, such as the FCM technique.

As will become clear below, the TPBP method may not be suitable or useful for certain types of image or in certain applications. For example, when the two classes of pixels to be separated are distant from each other in terms of either spatial position or intensity, the TPBP method may not be suitable or may not even be applicable.

Assuming a suitable 2D image has a plurality of pixels, which can be classified into two classes.

At S302, two sets of pixels within the plurality of pixels are selected, denoted S1 and S2. The two sets of pixels are selected based on at least two criteria.

First, each set of pixels meets at least one intensity requirement. This criterion is satisfied when the first set consists of pixels having intensities in a first range and the second set consists of pixels having intensities in a second range higher than the first range. The intensity ranges may be determined in different manners for different applications or image types. For example, the plurality of pixels may be clustered into two or more clusters based on intensity and the intensity ranges calculated from statistical measures of the clusters, as will be further illustrated below.

Secondly, each pixel within the two sets meets at least one spatial requirement: it neighbors at least one pixel from the other set. That is, the two sets consist of bordering pixels between the two classes. Depending on the coordinates used, the shape of the pixels and the particular application, neighboring pixels may be defined differently, as can be understood by persons skilled in the art. For example, with Cartesian coordinates and square pixels, two pixels are neighbors when they are 8-connected.

In one embodiment, the two sets of pixels are selected from two clusters of pixels, which are in turn selected from the plurality of pixels. The two clusters may be selected based on intensity such as by FCM so that the first cluster has a first intensity range and the second cluster has a second intensity range higher than the first range. For example, for an MR image of a head, the first cluster may correspond to brain tissues including white and grey matter and the second cluster may correspond to CSF. The first and second sets may be respectively selected from the first and second clusters, by requiring that each pixel selected from one cluster neighbors at least one pixel from the other cluster.

The two sets of pixels may also be selected based on additional intensity or spatial criteria. For instance, each pixel in the two sets may be at least a pre-selected distance (D) away from each one of a third set of pixels within the image, such as from a border of the image. For an MR image of a head the third set may consist of skull pixels and D may have a value of about 10 mm, to ensure that the selected pixels are at least 10 mm away from the skull pixels. As is apparent, the two sets of bordering pixels are within a ROI defined by the plurality of pixels but the third set of pixels may be outside of the ROI.

At S304, a statistical measure of intensity for each of the two bordering sets is determined, denoted P₁ for S1 and P₂ for S2 respectively. The statistical measure may be the respective average (arithmetic mean) intensity for each set. They may also be mean intensities, median intensities, mode intensities, or some other expected intensity values for each of the two sets. The choice of the particular type of statistical measures may depend on the particular application and the likely intensity distribution, and can be made by persons skilled in the art after reviewing this specification as well as the references cited herein.

At S306, the threshold (Iₜ) is computed as a weighted average of the two statistical measures:

Iₜ=αP₁+(1−α)P₂, (3)

where α is a constant such as from 0 to 1. The value of α may vary depending on the particular application, such as based on whether it is desirable to be over- or under-inclusive of pixels for certain classes of imaged matter.

As can be appreciated, the threshold is determined based on both spatial and intensity characteristics of different classes of pixels. The selection of the two sets may be made based on prior anatomical knowledge when the image is a brain image or other medical images. Advantageously, the threshold can lead to good results for a wide range of imaging types and conditions, particularly when the image have neighboring pixel classes that have significant overlapping intensities and/or low contrast. Averaging over the bordering pairs can also eliminate the effects of size difference between different clusters. As the threshold is used to separate the two bordering clusters, it may be advantageous to concentrate on separating the pairs of boundary pixels in the two bordering clusters.

FIG. 8 illustrates a process S400 of thresholding according to the MASD method, exemplary an embodiment of the present invention.

At S402, pixels in the ROI are classified into a plurality of clusters based on their intensity and spatial closeness (C1, . . . , CN). The classification can be carried out using a conventional classification technique, such as FCM or another suitable clustering or classification technique.

At S404, a mean intensity (Ī) and a standard deviation of intensity (σ) for one of the clusters are determined. The particular cluster is chosen depending on the type of thresholding desired. For eliminating the class of pixels having low intensities, the cluster may be a first cluster (C1). For eliminating the class of pixels having high intensities, the cluster may be a last cluster (CN).

At S406, the threshold is determined as

Iₜ=Ī+βσ, (4)

where β is a constant, such as from 0 to 3.

Although each process S300 or S400 is discussed above with reference to a 2D image, these methods can also be used for determining thresholds for segmenting three-dimensional (3D) images, as will be further illustrated below.

The particular implementation of the thresholding methods in process S200 are as follows.

At S244 (FIG. 5) of process S200, the SRCT method may be carried out by classifying the pixels in the ROI into two clusters by maximizing the between-class variance (as described in Hu(II), supra) with constrain of background proportion in the ROI. For instance, the total proportion of air, bone and CSF in the ROI may be limited to the range from 14 to 28%. The particular values for this range may be determined based on available clinical statistics.

The threshold that maximizes the between-class variance is then determined as the low threshold.

At S246 of process S200, the method S400 is implemented as follows. Pixels in the ROI are classified into 4 clusters (C1 to C4) by the FCM technique (at S402). The 4 clusters may respectively correspond to bone/air (C1), WM (C2), GM (C3), and CSF (C4).

As discussed above, the initial clusters are often unsatisfactory for segmentation purposes. For example, the maximum intensity of the first cluster (C1) (or the minimum intensity of the fourth cluster C4) is often not a good threshold for segmenting the image. The threshold is thus determined as follows.

The mean intensity (Ī^{C1}) and standard deviation of intensity (σ^{C1}) for the lowest cluster C1 are determined (at S404). These values can be readily calculated by persons skilled in the art.

The low threshold I_{t,l} is computed as (at S406):

I_{t,l}=Ī^{C1}+βσ^{C1}, (5)

where β is from 0 to 3. The actual value of β can be readily chosen by a person skilled in the art depending on the application. For example, if it is desirable to reduce misclassification of non-brain tissue as brain tissue, β may have a higher value, such as above 2. If it is desirable to reduce misclassification of brain tissue as non-brain tissue, β may have a smaller value, such as less than 1.

At S264 of process S200, the method S400 is implemented as follows. Pixels in the ROI are classified into 4 clusters (C1 to C4) by FCM (at S402), where the highest cluster (C4) corresponds to high intensity non-brain tissues such as bone marrow and adipose, and cluster C3 corresponds to WM or GM.

The mean intensity (Ī^{C4}) and standard deviation of intensity (σ^{C4}) for cluster C4 are calculated (at S404).

The high threshold I_{t,h} is computed as (at S406):

I_{t,h}=Ī^{C4}+βσ^{C4}, (6)

where β is from 0 to 3, but may have a different value as in equation (5).

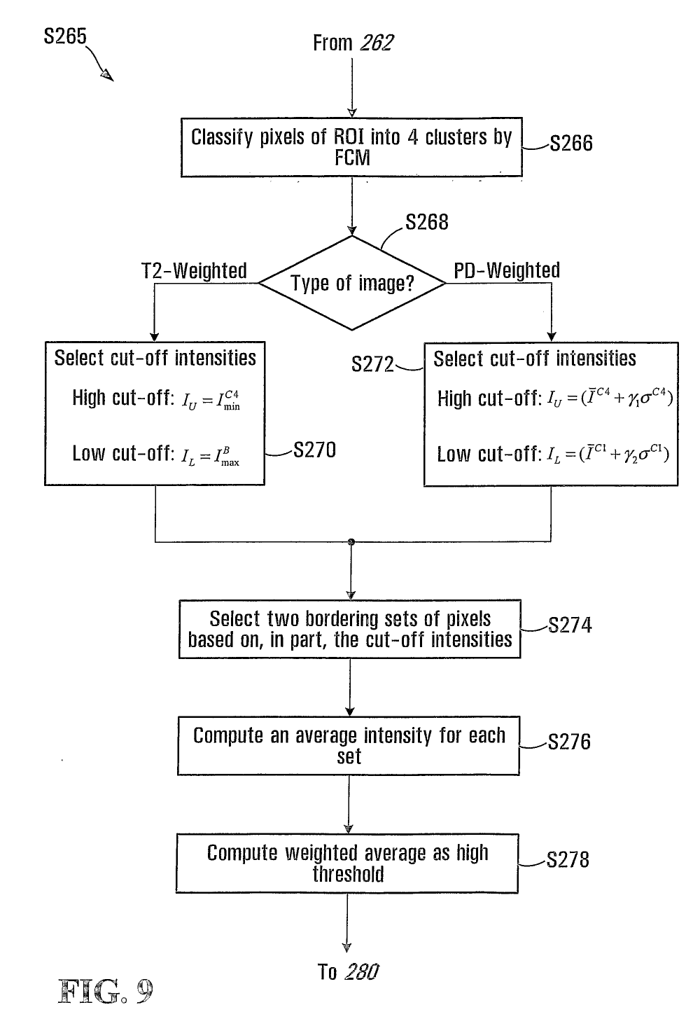

At S265 of process S200, the method S300 is implemented as illustrated in FIG. 9.

The bordering sets are first selected (S302, and S266, S268, S270, S272 and S274).

In this example, the first set of pixels are assumed to correspond to brain tissues including both GM and WM and the second set of pixels are assumed to correspond to CSF. As can be appreciated, the two sets of pixels are foreground pixels of the skull mask.

The spatial requirements are that each neighboring pair of a first set pixel and a second set pixel are 8-connected and each pixel in the two sets is at least 10 mm (i.e. distance D=10 mm) away from each background pixel (i.e., the third set of pixels are background pixels or skull pixels).

The intensity criteria are determined as follows. Pixels of the ROI are classified into 4 initial clusters by FCM (at S266). In this case, the highest initial cluster C4 corresponds to CSF, and cluster C3 corresponds to GM. However, the relative intensities between CSF and GM are different in T₂- and PD-weighted images. Thus, different intensity criteria are used for selecting the two bordering sets depending on whether the image is a T₂- or PD-weighted (S268).

For T₂-weighted images, high (or upper) and low intensity cut-offs are calculated by (S270):

I_{U}=Iₘᵢₙ^{C4}, and I_{L}=Iₘₐₓ^{B}, (7)

where Iₘᵢₙ^{C4} is the minimum intensity of cluster C4) and Iₘₐₓ^{B} is the maximum intensity of the background pixels in the ROI. Optionally, the low intensity cut-off I_{L} may be calculated from a statistical measure of the first or second initial cluster C1 or C2. For example, I_{L} may equal to the maximum intensity of C1 plus a constant such as 5, or, I_{L} may equal to the minimum intensity of C2 plus a constant.

For PD-weighted images, the high and low intensity cut-offs are calculated by (S272):

I_{U}=(Ī^{C4}+γ₁σ^{C4}), and I_{L}=(Ī^{C1}+γ₂σ^{C1}), (8)

where γ₁ is about 1 and where γ₂ is about 3.

Regardless of the image type, the intensity ranges for the two sets are respectively defined by:

I₁≧I_{U}, and I_{U}>I₂>I_{L}, (9)

where I₁ and I₂ are the respective intensities of pixels in the first and second sets.

The two bordering sets of pixels are selected based on, in part, equation (9), at S274. The selection of the two bordering sets is otherwise as described above in relation to method S300. All pixels meeting the intensity and spatial criteria are selected.

At S276, the average intensity (Ī₁ and Ī₂) for each set is respectively calculated. This corresponds to S304 and Ī₁ and Ī₂ are respectively the statistical measures P₁ and P₂ in equation (3).

At S278, and corresponding to S306 and equation (3), the high threshold intensity (I_{t,h}) is calculated as:

I_{t,h}=αĪ₁+(1+α)Ī₂, (10)

where α is from 0 to 1. The value of α may vary depending on the particular application, again based on whether it is desirable to be over- or under-inclusive of pixels for certain classes of tissues. If the cost to exclude brain tissues is bigger than the cost to include non-brain tissues in the segmentation, a should be bigger than 0.5. If both costs are equally important or one wants to have minimum classification error then a should be 0.5.

As illustrated in FIG. 2, once the low and high thresholds are determined, the reference slice or the whole image may be binarized at S280. For example, each voxel in the image may be associated with a value of 1 if its intensity is in the range from I_{t,l} to I_{t,h}, and a value of 0 if otherwise.

A binarization function or binarization mask B(x,y,z) can be constructed, where,

if I_{t,l}≦I(x,y,z)≦I_{t,h},B(x,y,z)=1; otherwise, B(x,y,z)=0. (11)

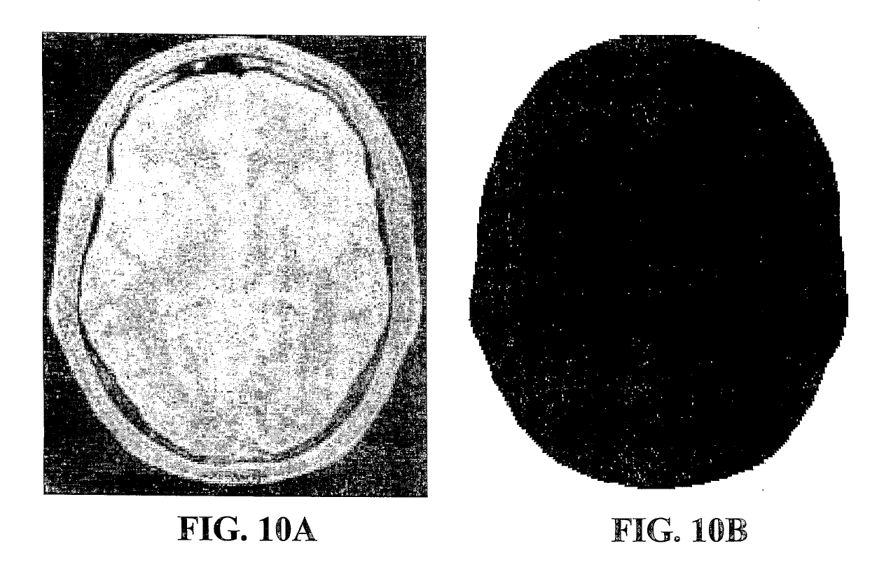

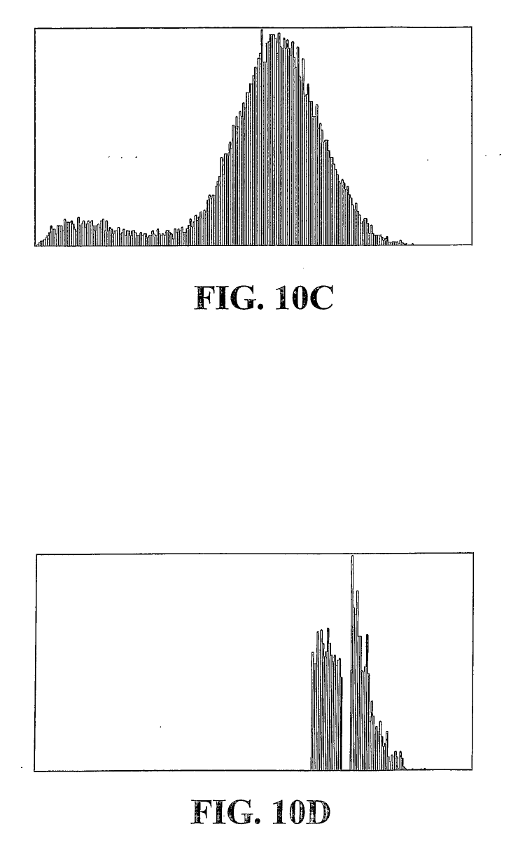

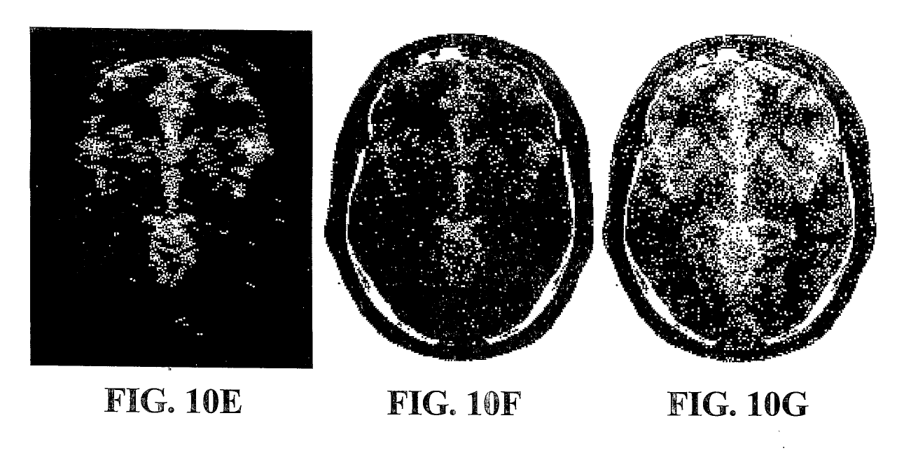

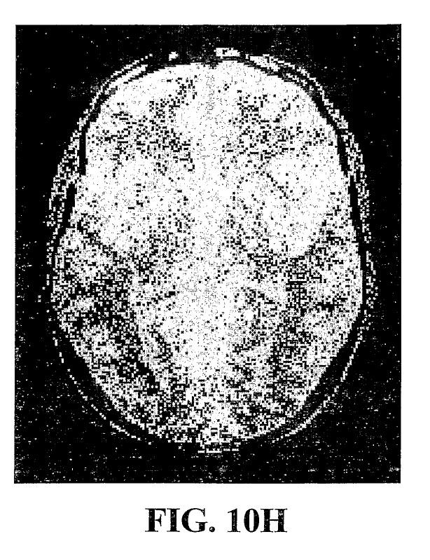

FIGS. 10A to 10H, 11A to 11C, 12A to 12C, and 13A to 13C show images of example reference slices and their segmentation according to process S200.

FIG. 10A is an image of an exemplary reference slice of a PD-weighted MR image of a human head, selected according process S200 at S210. FIG. 10B is a binarized image showing the ROI selected from the reference slice of FIG. 10A according to process S200 at S220.

The intensity histogram of all the pixels in the ROI is shown in FIG. 10C. The x-axis values indicate the pixel intensity and the y-axis values indicate the number of pixels at each intensity. As can be seen, the intensities of the pixels vary continuously and there is no obvious valley point for separating different classes of pixels at higher intensities.

FIG. 10D shows the intensity histogram of pixels at the boundary of grey matter (GM) and cerebrospinal fluid (CSF) in the ROI, where the boundary pairs were determined according to process S200 at S266, S272 and S274. In FIG. 10D the pixels have intensities in two distinct, narrow, and adjacent ranges, a lower range on the left and a higher range on the right. The GM pixels are in the lower range and the CSF pixels are in the higher range. As can be seen, the two ranges do not overlap.

FIG. 10E is a binarized image of the image of FIG. 10A showing the boundary pixels of FIG. 10D as white and non-boundary pixels as black.

FIG. 10F is a binarized image of the reference slice of FIG. 10A based on thresholds determined according to process S200, where the high threshold was determined using process S300 (the TPBP method) and the low threshold is determined according to equation (8) for “I_{L}”.

In comparison, FIG. 10G is a binarized image of the reference slice of FIG. 10A based on thresholds determined according to a simple FCM method, where the pixels in the ROI are classified into four clusters by FCM clustering and the low and high thresholds are respectively the minimum intensity of the second cluster and the maximum intensity of the third cluster.

As can be appreciated by persons skilled in the art after comparing FIGS. 10F and 10G, the TPBP method produces an improved result over the simple FCM method. As can be seen, much fewer pixels are excluded in FIG. 10F than in FIG. 10G (the excluded pixels are shown as white pixels). The reason for this difference is likely that, in this case, the TBPB method can more effectively reduce classification errors due to intensity overlap and low contrast. For example, WM pixels are more likely to be misclassified in the simple FCM method due to substantial intensity overlap and low image contrast near the lower intensity limit of the WM pixels.

FIG. 10H is a segmented image of the ROI of FIG. 10B according to process S200. As can be appreciated, classification errors may exist in the segmented image. For example, some skull pixels are visible in FIG. H as a result of misclassification due to factors such as noise and image in homogeneity.

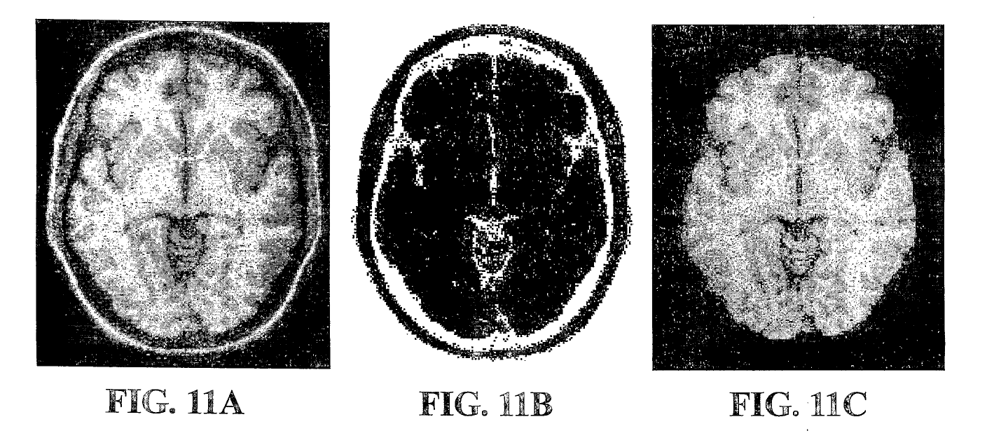

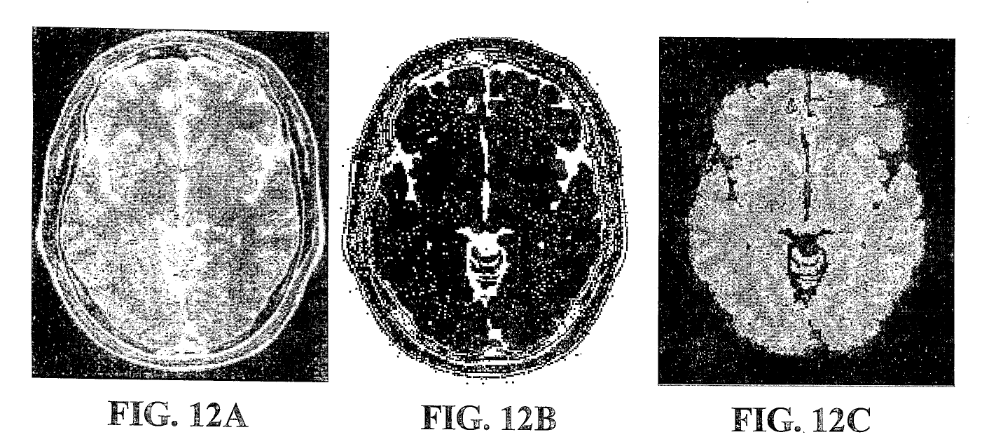

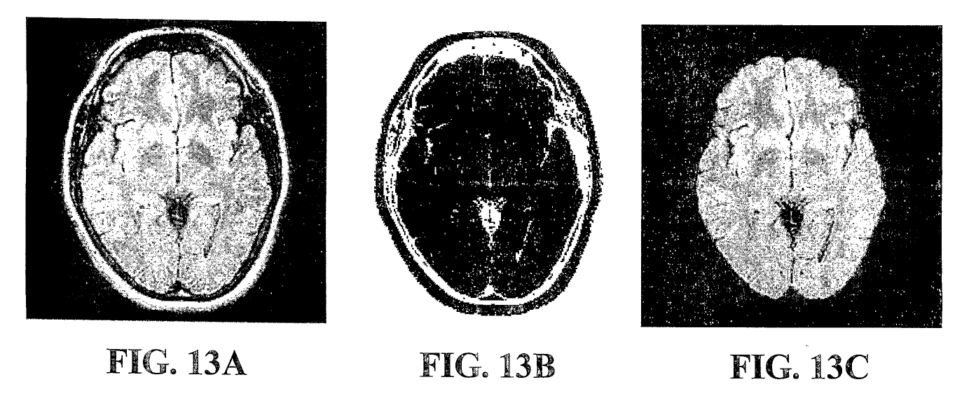

FIG. 11A shows a typical reference slice of a T1-weighted MR image of a human head. FIG. 11B shows a binarized image of FIG. 11A and FIG. 11C shows a segmented image of FIG. 11A based on the binarized image of FIG. 11B. Similarly, FIGS. 12A to 12C respectively show reference, binarized, and segmented images of a T2-weighted MR image; and FIGS. 13A to 13C respectively show reference, binarized, and segmented images of a FLAIR MR image. All of these segmented images were segmented according to process S200.

As can be appreciated by persons skilled in the art, the segmented images are of good quality for all four different types of MR images.

It can be appreciated that in different embodiments, an image may be classified into more or less than four clusters, depending on the type of images and tissue classes of interest. In some applications, a classification step may be performed with a suitable technique other than the FCM technique, as will be understood by a person skilled in the art.

It should also be understood that intensity of the image may be represented in any suitable manner and in any color. For example, in a single contrast grey scale image, a high intensity may be represented in either light or dark color.

As can be understood, in process S200, an intensity threshold may be determined from any suitable subset of voxels of the 3D image, which need not be a 2D slice of the 3D image. A suitable subset should have voxels associated with each possible classes of voxels so that the subset is sufficiently representative of the whole set. For certain types of images, the suitable subset may include connected voxels, so that both intensity and spatial requirements may be used for determining the threshold.

The exemplary embodiments described herein can have wide applications in image processing, including medical image processing and other types of image processing. The thresholding methods according to aspects of the present invention can be readily implemented for various situations and types of images. Good performance can be expected even when there is heavy noise and inhomogeneity.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

1. A method of segmenting a plurality of pixels of an image based on intensity, said method comprising:
selecting first and second clusters of pixels from said plurality of pixels, said first cluster of pixels having intensities in a first range, said second cluster of pixels having intensities in a second range, said intensities in said second range being higher than said intensities in said first range;
selecting a first set of pixels from said first cluster and a second set of pixels from said second cluster, wherein each pixel of said first and second sets neighbors at least one pixel from the other one of said first and second sets in said image;
determining a statistical measure of intensity of said first set of pixels and a statistical measure of intensity of said second set of pixels; and
computing an intensity threshold value from said statistical measures for segmenting said plurality of pixels.

2. The method of claim 1, wherein said plurality of pixels are clustered into a plurality of clusters each having a ranking in intensity, said first and second clusters having adjacent rankings in intensity.

3. The method of claim 1, wherein said intensity threshold value is calculated as a weighted average of said statistical measures.

4. The method of claim 1, wherein said statistical measures are respectively P₁ and P₂ and said intensity threshold value is Iₜ, where Iₜ=αP₁+(1−α) P₂, a being a number from 0 to 1.

5. The method of claim 1, wherein each one of said statistical measures is selected from a mean, a median, and a mode.

6. The method of claim 5, wherein said each one of said statistical measures is an arithmetic mean.

7. The method of claim 1, wherein said image is an image of a head.

8. The method of claim 7, each pixel of said first and second sets is at least a pre-selected distance away from each one of a third set of pixels of said image.

9. The method of claim 8, wherein said third set of pixels are designated as skull pixels.

10. The method of claim 9, wherein said plurality of pixels are within a selected region of interest in said image.

11. The method of claim 10, wherein said region of interest is a region defined by said skull pixels.

12. The method of claim 9, wherein said pre-selected distance is about 10 mm.

13. The method of claim 8, wherein each pixel of said first and second sets is 8-connected to at least one pixel of the other set.

14. The method of claim 8, wherein each pixel of said first and second sets is 4-connected to at least one pixel of the other set.

15. The method of claim 8, further comprising designating each one of said plurality of pixels as one of a background pixel and a foreground pixel in a skull mask, wherein said first and second clusters of pixels are selected from foreground pixels of said skull mask.

16. The method of claim 15, wherein one of said first and second clusters corresponds to grey matter and white matter, and the other of said first and second clusters corresponds to cerebrospinal fluid.

17. The method of claim 16, wherein said selecting said first and second clusters comprises clustering said plurality of pixels into a first initial cluster (C1) corresponding to a non-brain tissue, a second initial cluster (C2) corresponding to white matter, a third initial cluster (C3) corresponding to grey matter, and a fourth initial cluster (C4) corresponding to cerebrospinal fluid.

18. The method of claim 17, wherein said clustering comprises fuzzy C-means clustering.

19. The method of claim 17, wherein said image is a T₂-weighted magnetic resonance image.

20. The method of claim 19, wherein said fourth initial cluster has a minimum intensity value Iₘᵢₙ^{c4}, said background pixels having a maximum intensity value Iₘₐₓ^{b} said first range being between Iₘₐₓ^{b} and Iₘᵢₙ^{c4}, said second range being≧Iₘᵢₙ^{c4}.

21. The method of claim 17, wherein said image is a proton density (PD)-weighted magnetic resonance image.

22. The method of claim 21, wherein said first initial cluster has a mean intensity value Ī^{C1} and a standard deviation of intensity σ^{C1}, said fourth initial cluster has a mean intensity value Ī^{C4} and a standard deviation of intensity σ^{C4}, said first range being between (Ī^{C1}+γ₂σ^{C1}) and (Ī^{C4}+γ₁σ^{C4}), said second range being≧(Ī^{C4}+γ₁σ^{C4}), where γ₁ is about 1 and γ₂ is about 3.

23. A method of segmenting a plurality of pixels of an image based on intensity, said method comprising:
clustering said plurality of pixels into a plurality of clusters each having pixels of intensities in a respective range;
determining a mean intensity value Ī and a standard deviation σ from Ī for pixels in one of said clusters; and
determining an intensity threshold value Iₜ for segmenting said plurality of pixels, wherein Iₜ=Ī+βσ, β being a number from 0 to about 3.

24. The method of claim 23, wherein said clustering comprises fuzzy C-means clustering.

25. The method of claim 23, wherein said image is an image of a head of a subject.

26. The method of claim 25, wherein said image is a magnetic resonance image, and said plurality of clusters comprises four clusters corresponding to, respectively, a non-brain tissue, white matter, grey matter, and cerebrospinal fluid.

27. The method of claim 26, wherein said magnetic resonance image is one of T₂-weighted and proton-density weighted images, said one cluster having the lowest intensity ranking within said four clusters.

28. The method of claim 27, wherein β is from 0 to 3.

29. The method of claim 26, wherein said magnetic resonance image is one of a T₁-weighted image, a spoiled gradient-recalled (SPGR) image, and a fluid attenuation inversion recovery (FLAIR) image, and said one cluster having the highest intensity ranking within said four clusters.

30. The method of claim 29, wherein β is about 3.

31. A method of segmenting a three-dimensional (3D) image based on intensity, said 3D image comprising a set of voxels each having an intensity and being associated with one of a plurality of voxel classes, said method comprising:
selecting a subset of said set of voxels, said subset having voxels respectively associated with each one of said voxel classes;
determining an intensity threshold from said subset of voxels; and
segmenting said 3D image according to said intensity threshold.

32. The method of claim 31, wherein said selecting comprises selecting a two-dimensional (2D) slice in said 3D image, said subset of voxels comprising voxels in said 2D slice.

33. The method of claim 31, wherein said intensity threshold is determined according to a method of any one of claims 1 to 30.

34. The method of claim 31, wherein said determining an intensity threshold comprises determining a low threshold and a high threshold, and said 3D image is segmented according to both of said low and high thresholds.

35. The method of claim 34, wherein said 3D image is a magnetic resonance image of a head of a subject.

36. The method of claim 35, wherein each one of said first and second intensity thresholds is determined according to a respective thresholding method dependent on the image type of said 3D image.

37. The method of claim 36, wherein said low and high thresholds are respectively determined according to different thresholding methods.

38. The method of claim 37, wherein said 3D image is one of a T₂-weighted image and a PD-weighted image.

39. (canceled)

40. The method of claim 37, wherein said 3D image is one of a T₁-weighted image, a spoiled gradient-recalled (SPGR) image, and a fluid attenuation inversion recovery (FLAIR) image.

41. The method of claim 40, wherein said determining said low and high thresholds comprising determining said low threshold according to a supervised range-constrained thresholding (SRCT) method.

42. The method of claim 31, wherein said determining an intensity threshold comprises classifying said subset of voxels by fuzzy C-means clustering.

43. The method of claim 32, further comprising determining a region of interest in said 2D slice.

44. The method of claim 43, wherein said 3D image is an image of a head of a subject, said determining a region of interest comprising:
classifying said subset of voxels into background voxels having intensities in a first range and foreground voxels having intensities in a second range, said intensities in said second range being higher than said intensities in said first range; and
finding the largest group of connected foreground voxels, said largest group of connected foreground voxels and said subset of voxels surrounded by said largest group of connected foreground voxels forming said region of interest.

45. The method of claim 44, wherein said classifying comprises clustering said subset of voxels into a plurality of clusters, each cluster corresponding to an identifiable tissue class.

46. The method of claim 45, wherein said clustering comprises fuzzy C-means.

47. The method of claim 46, wherein said pixels of said image being clustered into four clusters corresponding to, respectively, a non-brain tissue, white matter, grey matter, and cerebrospinal fluid.

48. The method of claim 47, wherein said image is a magnetic resonance image.

49. The method of claim 48, wherein said first range is below an intensity threshold value and said second range is above said threshold value, said threshold value equals to the sum of a constant and the maximum intensity of the cluster having the lowest intensity ranking within said four clusters.

50. The method of claim 49 wherein said constant is 5.

51. The method of claim 1, comprising segmenting said image based on, at least in part, said intensity threshold value.

52. A computer readable medium storing thereon computer executable code, said code when executed by a processor of a computer causes said computer to carry out the method of claim 1.

53. A computing device comprising a processor and persistent storage memory in communication with said processor storing processor executable instructions adapting said device to carry out the method of claim 1.

54. An apparatus for segmenting a plurality of pixels of an image, comprising:
means for selecting first and second clusters of pixels from said plurality of pixels, said first cluster of pixels having intensities in a first range, said second cluster of pixels having intensities in a second range, said intensities in said second range being higher than said intensities in said first range;
means for selecting a first set of pixels from said first cluster and a second set of pixels from said second cluster, wherein each pixel of said first and second sets neighbors at least one pixel from the other one of said first and second sets in said image;
means for determining a statistical measure of intensity of said first set of pixels and a statistical measure of intensity of said second set of pixels; and
means for computing an intensity threshold value from said statistical measures for segmenting said plurality of pixels.

55. An apparatus for segmenting a plurality of pixels of an image, comprising:
means for clustering said plurality of pixels into a plurality of clusters each having pixels of intensities in a respective range;
means for determining a mean intensity value Ī and a standard deviation σ from Ī for one of said clusters; and
means for determining an intensity threshold value Iₜ for segmenting said plurality of pixels, wherein Iₜ=Ī+ασ, α being a number from 0 to about 3.

56. An apparatus for segmenting a three-dimensional (3D) image, said 3D image comprising a set of voxels each having an intensity and being associated with one of a plurality of voxel classes, said apparatus comprising:
means for selecting a subset of said set of voxels, said subset having voxels respectively associated with each one of said voxel classes;
means for determining an intensity threshold from said subset of voxels; and
means for segmenting said 3D image according to said intensity threshold.
